(19) United States
(12) Patent Application Publication
(10) Pub. No.: US 2024/0396911 A1
(43) Pub. Date: Nov. 28, 2024

(54) SYSTEMS AND METHODS FOR DETECTING AND PREVENTING BOT TRAFFIC IN MESSAGING SYSTEMS

(71) Applicant: Pushnami LLC, Austin, TX (US)

(72) Inventors: Mitchell Taylor, Austin, TX (US); Emerson Smith, Austin, TX (US)

(21) Appl. No.: 18/668,372

(22) Filed: May 20, 2024

Related U.S. Application Data
(60) Provisional application No. 63/503,625, filed on May 22, 2023.

(51) Int. Cl. H04L 9/40

(52) U.S. Cl. CPC H04L 63/1425; H04L 63/1416

(57) ABSTRACT

Systems and methods for fraud detection in notification systems and networks are disclosed. These systems and methods are adapted to determine if users in a notification network undesirable automated users and prevent notifications from being sent to such users.

### RELATED APPLICATION(S)

This patent application claims the benefit of priority under 35 U.S.C. 119 to U.S. Provisional Patent Application Ser. No. 63/503,625, filed May 22, 2023, entitled “Systems and Methods For Detecting And Preventing Bot Traffic In Messaging Systems” by inventors Taylor and Smith, which is incorporated herein in its entirety by reference for all purposes.

### TECHNICAL FIELD

This disclosure relates generally to messaging systems. Specifically, this disclosure relates to automatic fraud detection and prevention in such messaging systems. Even more particularly, this disclosure relates to the detection and prevention of bot traffic in the context of messaging for push based notifications.

### BACKGROUND

In the current online environment, it is desirable to contact users at various points during the online activity. Certain notification systems may thus be provided to contact these users, including contacting these users based on their online activity (e.g., by email, messaging or push notifications, including SMS or MMS, etc.). For example, based on a variety of criteria, notification systems may determine that notifications are to be sent to users. One or more notifications can then be generated for these users. The generation of these notifications may entail a number of actions, including obtaining content, rendering templates, etc. associated with the notification, and sending the notification through a delivery channel (or providing the notification to a service or other application for delivering the notification through the notification channel).

Internet bots may present a large problem in such ecosystems. An Internet bot, web robot, robot or simply bot, is a software application that runs automated tasks (e.g., scripts in a headless browser) in the context of a network (e.g., the Internet) usually with the intent to imitate human activity on the Internet. These bots are a large problem in the context of notification because bots interacting with such notifications may reduce the quality of users in the notification network and the value of such notifications to their providers or other entities associated with the notifications.

Current techniques for combatting bot fraud are inadequate, especially in such a notification environment. Specifically, in a notification network typical bot prevention or detection techniques may fail to prevent the use of bots or bot propagation. Moreover, these bot detection or prevention techniques may also fail to adapt to retooling of bots or other fraud agents by malicious actors.

What is desired, therefore, are improved systems and methods for bot detection or prevention that will be effective in a notification environment.

### SUMMARY

As may be realized, in the current online environment it is desirable to contact users at various points during the online activity. Certain notification systems may thus be provided to contact these users, including contacting these users based on their online activity (e.g., by email, messaging or push notifications, including SMS or MMS, etc.). For example, based on a variety of criteria, notification systems may determine that notifications are to be sent to users (e.g., in some cases subscribers or participating users who have indicated a receptiveness to such notifications). One or more notifications can then be generated for these users. The generation of these notifications may entail a number of actions, including obtaining content, rendering templates, etc. associated with the notification, and sending the notification through a delivery channel (or providing the notification to a service or other application for delivering the notification through the notification channel).

As can be imagined, given the size and scale of the Internet and its users and the delivery channels for such notifications, the number of notifications generated, sent, or delivered over a relatively short time period may be astronomical (e.g., in the billions or more), and commensurately the number of notifications may also be incredibly voluminous.

The subscription of users to such notifications and the subsequent delivery of such (e.g., push) notifications thus offer the opportunity for the delivery of notifications of many different types such as advertising or other types of notifications aimed at prompting actions by users. These types of notifications may be associated with the payment or other transfer of remuneration between various parties in a notification network, including between operators of web sites whose users have subscribed to such notifications, publishers of web content, advertisers providing ad content or other parties.

Internet bots may present a large problem in such ecosystems. An Internet bot, web robot, robot or simply bot, is a software application that runs automated tasks (e.g., scripts in a headless browser) in the context of a network (e.g., the Internet) usually with the intent to imitate human activity on the Internet. These bots are a large problem in the context of notification because bots interacting with such notifications (e.g., which may be ads) take away from the value and revenue associated with an advertising click. These bots can subscribe to push notifications in a notification environment, and also click on them. This reduces the quality of users in the notification network and the value of the internet advertising process.

Additionally, this bot fraud in advertising systems can spread across a notification network by repeatedly clicking and subscribing. This has the effect of reducing quality for people desiring notification be sent (e.g., advertisers) and displacing traffic from legitimate users. In essence, a bot is fooling the notification system into thinking that the bot is a legitimate user, which means that all the algorithms and sending processes in the notification network are hampered because they utilize or perform processing based on the misleading information associated with the bot. To illustrate in more detail, in these notification environments there may be typical users, manual fraud committed by human users (e.g., a person clicking on a notification multiple times), and automated fraud which include bots capable of subscribing to a notification network and then interacting with subsequent notifications (e.g., ads). To operate in such notification environments, the bots may be quite sophisticated, including bots that can subscribe to notifications and then interact with subsequent notifications issued based on that subscription. Because of the structure of notification networks these sophisticated bots may propagate quite quickly. In some cases, this is because there may be links between publisher sites that utilize such notification networks that the bots can easily follow. Additionally, the algorithms or analytics utilized in such notification networks may contribute to the proliferation of such bots. Namely, these algorithms may tend to send more notifications to users that interact with such notifications, where these notifications may include links to other sites. Thus, these bots may cause a feedback loop that initiates propagation of these bots. Not only may this cause undue charges to be applied to parties within the network, but additionally the constant delivery of these notifications (and the associated processing and traffic) to illegitimate users may significantly bog down such notification networks.

Because fraud that utilizes these types of automated bots is sophisticated and widespread—using a headless browser or the like to emulate users, having fake user agents, operating on a botnet with different IP addresses, these bots (or their actions) tend to closely emulate human users and thus are difficult to detect via the application of traditional fraud detection techniques. In particular these automated users may closely resemble a human user with respect to interactions in association with a single site.

While signature detection is one common prior solution to combating bot fraud, such signature detection may be inadequate in the context of notification systems. This signature based detection relies on predefined patterns, or “signatures”, which are known indicators of fraudulent behavior. These signatures can be specific data points, sequences of events, or combinations of factors that have historically been associated with fraud. Accordingly, while signature detection is effective to combat known and previously identified fraud, it fails to address new fraud patterns. Moreover, malicious actors are familiar with how brittle this approach can be and are typically able to bypass signature detection by making minor changes to their fraud pattern. This is sometimes referred to as “retooling”. Additionally, signature detection only identifies specific cases of fraud which does not necessarily identify similar types of fraud being committed across the network by the same actor.

Further complicating the use of signature detection is the low intent environment in which notification systems may operate. In these types of environments, notification systems may not receive highly detailed tracking or other data regarding a user's specific interactions with a website. Instead, a notification system may only be informed that a user is interacting with a website and that a notification should be sent. This lack of detailed data regarding user's actions with respect to a website through which notifications are to be delivered may complicate determination of whether such a user is a bot.

Other techniques for combatting bot fraud may also be inadequate in such a notification environment. In a notification network these techniques may fail to prevent bot propagation. In particular, certain of these techniques may rely on discrete observations which may be inconsistently met by a single malicious actor in a network. In a notification network, the bot acts in a similar way to a human so such activity may not be detected. Moreover, these techniques may also fail to adapt to retooling of bots or other fraud agents by malicious actors.

To address these problems, among others, embodiments of fraud detection engines (also referred to as fraud application engines) used in such notification systems can assess behavior of users across the notification network to determine if those users are undesirable automated users (used interchangeably herein with the term bot) by analyzing behavior with respect to identifiers associated with the user, a user's device, or other user characteristics.

As the notification system may be associated (e.g., manage) subscriptions and delivery of notification for multiple (publisher) sites, the notification system may be uniquely positioned to track user behavior or other user data associated with a user's interactions across these multiple sites, and associate this behavior across these sites with the same identifier. The fraud detection engine may analyze this behavior (e.g. with respect to a single site or multiple sites) to determine which users are undesirable automated users (e.g., bots). This analysis can be done, for example, utilizing heuristic engines, and applying such heuristic engines to user data collected during the user's interaction with the notifications or multiple sites. These heuristic engines may include models trained on the user data associated with user's interaction with the notification system or the publisher's sites, where these models may include, for example, rules based models, machine learning models or other types of models.

Such analysis may occur dynamically, in real time, or may be off-line analysis that may occur, for example, on a periodic basis, such as nightly or the like. To illustrate first with respect to real-time fraud detection, as notification systems may operate to allow a user to opt in, or subscribe, to (e.g., push) notifications, such a fraud analysis may take place at least at two points in real-time during a user's interactions with such a notification system or publisher's web site or when notifications are sent to the user (e.g., based on a user's interaction with such notifications). Namely, before a user is presented with an opt-in or subscription request (e.g., is presented with an option to accept/opt-in or decline a subscription request) or after a user accepts a subscription request, a fraud analysis may be performed. Such a fraud analysis may include a check to see if the identifier associated with the user has previously been blocked. If the identifier has been blocked, the user may be denied access. Moreover, blocked data may be added to the user's device to identify the user as blocked.

If the identifier associated with the user has not been blocked, a heuristic engine may be applied to determine if the user is a bot. If the user is identified as a bot, the identifier associated with the user can be added to a blocked list. Moreover, any subscriptions to notifications (e.g., from other sites) associated with the identifier may be removed at the notification system such that interactions with that user may be curtailed or eliminated in association with other sites as well.

Fraud detection may also take place asynchronously to user interaction with the notification system. Here, at some time interval heuristic engines may be applied to user data associated with a user identifier. These heuristic engines may be adapted to apply fraud detection to user's interaction across web sites to detect if such interactions across web sites indicate that the user is a bot. For example, if a subscription to notification is detected in association with a certain number of sites in a certain time period, this user may be determined to be a bot. If the user is identified as a bot, the identifier associated with the user can be added to a blocked list. Moreover, any subscriptions to notifications (e.g., from other sites) associated with the identifier may be removed at the notification system such that interactions with that user may be curtailed or eliminated in association with other sites as well.

Accordingly, embodiments may apply fraud detection in real time during, or subsequently to, each of these interactions. In certain embodiments, then, the heuristic engines (e.g., models) applied to detect fraud may be tailored to the particular context in which they will be applied. For example, heuristic engines may be tailored for real-time application, asynchronous application, application before a subscription notification is sent, etc. Moreover, when such fraud is detected for a user (e.g., the user is determined to be a bot, or other type of undesirable automated user), the identifier may be added to a blocked list such that the user is blocked even when that user interacts with other web sites. In other words, the user can be simultaneously blocked across all publisher web sites in the notification environment (e.g., even if that user is detected as fraudulent with respect to less than all of the publisher web sites).

Specifically, as these notification systems may be multi-tenant systems (e.g., that may be deployed in a cloud based computing platform or virtualized computing platform, etc.) designed to send notifications (e.g., advertisements) for multiple campaigns for multiple content providers (e.g., also referred to as “accounts” of the notification system) having multiple websites (also referred to as domains) embodiments may be capable of detecting fraud before the generation and sending of these notifications, thus ensuring that the notification system is not burdened by the unnecessary sending of such notifications and that entities are not improperly charged for the distribution of such notification.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features and wherein:

FIGS. 1A and 1B are a diagrammatic representation of an architecture including an embodiment of a notification system.

FIG. 2 is a diagrammatic representation of fraud detection in notification systems.

FIG. 3 is a flow representation of an embodiment of a method for asynchronous fraud detection in a notification system.

FIGS. 4A, 4B, and 4C are a flow representation of an embodiment of a method for online fraud detection in a notification system.

### DETAILED DESCRIPTION

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the embodiments in detail. It should be understood, however, that the detailed description and the specific examples are given by way of illustration only and not by way of limitation. Various substitutions, modifications, additions and/or rearrangements within the spirit and/or scope of the underlying inventive concept will become apparent to those skilled in the art from this disclosure.

Before discussing embodiments in more detail a brief description of the context in which embodiments can be utilized may be helpful. Namely, digital notification systems. It will be noted, however, that while embodiments as described herein may be described in such a context, embodiments may be equally effectively employed in other contexts where bot prevention and detection in the context of messaging are utilized, and all such amendments are fully contemplated herein without loss of generality.

As may be realized, in the current online environment it is desirable to contact users at various points during the online activity. Certain notification systems may thus be provided to contact these users, including contacting these users based on their online activity (e.g., by email, messaging or push notifications, including SMS or MMS, etc.). For example, based on a variety of criteria, notification systems may determine that notifications are to be sent to users (e.g., in some cases subscribers or participating users who have indicated a receptiveness to such notifications). One or more notifications can then be generated for these users. The generation of these notifications may entail a number of actions, including obtaining content, rendering templates, etc. associated with the notification, and sending the notification through a delivery channel (or providing the notification to a service or other application for delivering the notification through the notification channel).

As can be imagined, given the size and scale of the Internet and its users and the delivery channels for such notifications, the number of notifications generated, sent, or delivered over a relatively short time period may be astronomical (e.g., in the billions or more), and commensurately the number of notifications may also be incredibly voluminous.

The subscription of users to such notifications and the subsequent delivery of such (e.g., push) notifications thus offer the opportunity for the delivery of notifications of many different types such as advertising or other types of notifications aimed at prompting actions by users. These types of notifications may be associated with the payment or other transfer of remuneration between various parties in a notification network, including between operators of web sites whose users have subscribed to such notifications, publishers of web content, advertisers providing ad content or other parties.

Internet bots may present a large problem in such ecosystems. An Internet bot, web robot, robot or simply bot, is a software application that runs automated tasks (e.g., scripts in a headless browser) in the context of a network (e.g., the Internet) usually with the intent to imitate human activity on the Internet. These bots are a large problem in the context of notification because bots interact with such notifications (e.g., which may be ads) and take away from the value and revenue associated with an advertising click. These bots can subscribe to push notifications in a notification environment, and also click on them. This reduces the quality of users in the notification network and the value of the internet advertising process.

Additionally, this bot fraud in advertising systems can spread across a notification network by repeatedly clicking and subscribing. This has the effect of reducing quality for people desiring notification be sent (e.g., advertisers) and displacing traffic from legitimate users. In essence, a bot is fooling the notification system into thinking that the bot is a legitimate user, which means that all the algorithms and sending processes in the notification network are hampered because they utilize or perform processing based on the misleading information associated with the bot.

To illustrate in more detail, in these notification environments there may be typical users, manual fraud committed by human users (e.g., a person clicking on a notification multiple times), and automated fraud which include bots capable of subscribing to a notification network and then interacting with subsequent notifications (e.g., ads). To operate in such notification environments, the bots may be quite sophisticated, including bots that can subscribe to notifications and then interact with subsequent notifications issued based on that subscription. Because of the structure of notification networks these sophisticated bots may propagate quite quickly. In some cases, this is because there may be links between publisher sites that utilize such notification networks that the bots can easily follow. Additionally, the algorithms or analytics utilized in such notification networks may contribute to the proliferation of such bots. Namely, these algorithms may tend to send more notifications to users that interact with such notifications, where these notifications may include links to other sites. Thus, these bots may cause a feedback loop that initiates propagation of these bots. Not only may this cause undue charges to be applied to parties within the network, but additionally the constant delivery of these notifications (and the associated processing and traffic) to illegitimate users may significantly bog down such notification networks.

Because fraud that utilizes these types of automated bots is sophisticated and widespread-using a headless browser or the like to emulate users, having fake user agents, operating on a botnet with different IP addresses, these bots (or their actions) tend to closely emulate human users and thus are difficult to detect via the application of traditional fraud detection techniques. In particular these automated users may closely resemble a human user with respect to interactions in association with a single site.

While signature detection is one common prior solution to combating bot fraud, such signature detection may be inadequate in the context of notification systems. This signature based detection relies on predefined patterns, or “signatures”, which are known indicators of fraudulent behavior. These signatures can be specific data points, sequences of events, or combinations of factors that have historically been associated with fraud. Accordingly, while signature detection is effective to combat known and previously identified fraud, it fails to address new fraud patterns. Moreover, malicious actors are familiar with how brittle this approach can be and are typically able to bypass signature detection by making minor changes to their fraud pattern. This is sometimes referred to as “retooling”. Additionally, signature detection only identifies specific cases of fraud which does not necessarily identify similar types of fraud being committed across the network by the same actor.

Moreover, implementation of any kind of interactive detection system for detecting human or bot users, such as CAPTCHA or the like, may be next to impossible to implement for a notification system. Namely, providers of websites through which such notifications may be provided may not desire, or allow, providers of notifications to interact with users or to impose additional friction with respect to interaction with that provider's website.

To address these problems, among others, embodiments of fraud detection engines (also referred to as fraud application engines) used in such notification systems can assess behavior of users across the notification network to determine if those users are undesirable automated users (used interchangeably herein with the term bot) by analyzing behavior with respect to identifiers associated with the user, a user's device or other user characteristics. As the notification system may be associated (e.g., manage) subscriptions and delivery of notification for multiple (publisher) sites, the notification system may be uniquely positioned to track user behavior or other user data associated with a user's interactions across these multiple sites, and associate this behavior across these sites with the same identifier. The fraud detection engine may analyze this behavior (e.g. with respect to a single site or multiple sites) to determine which users are undesirable automated users (e.g., bots). This analysis can be done, for example, utilizing heuristic engines, and applying such heuristic engines to user data collected during the user's interaction with the notifications or multiple sites. These heuristic engines may include models trained on the user data associated with user's interaction with the notification system or the publisher's sites, where these models may include, for example, rules based models, machine learning models or other types of models.

Such analysis may occur dynamically, in real time, or may be off-line analysis that may occur, for example, on a periodic basis, such as nightly or the like. To illustrate first with respect to real-time fraud detection, as notification systems may operate to allow a user to opt in, or subscribe, to (e.g., push) notifications, such a fraud analysis may take place at least at two points in real-time during a user's interactions with such a notification system or publisher's web site or when notifications are sent to the user (e.g., based on a user's interaction with such notifications). Namely, before a user is presented with an opt-in or subscription request (e.g., is presented with an option to accept/opt-in or decline a subscription request) or after a user accepts a subscription request, a fraud analysis may be performed. Such a fraud analysis may include a check to see if the identifier associated with the user has previously been blocked. If the identifier has been blocked, the user may be denied access. In one embodiment, the user may be (re) directed to a blocked access web page that may be associated with the website that the user is accessing (e.g., provided by the provider of that website, associated with the same domain, etc.). As may be realized, bot detection by a notification system may be beneficial to the notification system and to the providers of the website, as bot interaction with both systems may be curtailed through use of single detection (e.g., at the notification system).

Moreover, blocked data may be added to the user's device to identify the user as blocked. If not (e.g., the identifier associated with the user has not been blocked), a heuristic engine may be applied to determine if the user is a bot. If the user is identified as a bot, the identifier associated with the user can be added to a blocked list. Moreover, any subscriptions to notifications (e.g., from other sites) associated with the identifier may be removed at the notification system such that interactions with that user may be curtailed or eliminated in association with other sites as well.

Fraud detection may also take place asynchronously to user interaction with the notification system. Here, at some time interval heuristic engines may be applied to user data associated with a user identifier. These heuristic engines may be adapted to apply fraud detection to user's interaction across web sites to detect if such interactions across web sites indicate that the user is a bot. For example, if a subscription to notification is detected in association with a certain number of sites in a certain time period, this user may be determined to be a bot. If the user is identified as a bot, the identifier associated with the user can be added to a blocked list. Moreover, any subscriptions to notifications (e.g., from other sites) associated with the identifier may be removed at the notification system such that interactions with that user may be curtailed or eliminated in association with other sites as well.

Accordingly, embodiments may apply fraud detection in real time during, or subsequently to, each of these interactions. In certain embodiments, then, the heuristic engines (e.g., models) applied to detect fraud may be tailored to the particular context in which they will be applied. For example, heuristic engines may be tailored for real-time application, asynchronous application, application before a subscription notification is sent, etc. Moreover, when such fraud is detected for a user (e.g., the user is determined to be a bot, or other type of undesirable automated user), the identifier may be added to a blocked list such that the user is blocked even when that user interacts with other web sites. In other words, the user can be simultaneously blocked across all publisher web sites in the notification environment (e.g., even if that user is detected as fraudulent with respect to less than all of the publisher web sites).

Specifically, as these notification systems may be multi-tenant systems (e.g., that may be deployed in a cloud based computing platform or virtualized computing platform, etc.) designed to send notifications (e.g., advertisements) for multiple campaigns for multiple content providers (e.g., also referred to as “accounts” of the notification system) having multiple websites (also referred to as domains) embodiments may be capable of detecting fraud before the generation and sending of these notifications, thus ensuring that the notification system is not burdened by the unnecessary sending of such notifications and that entities are not improperly charged for the distribution of such notification.

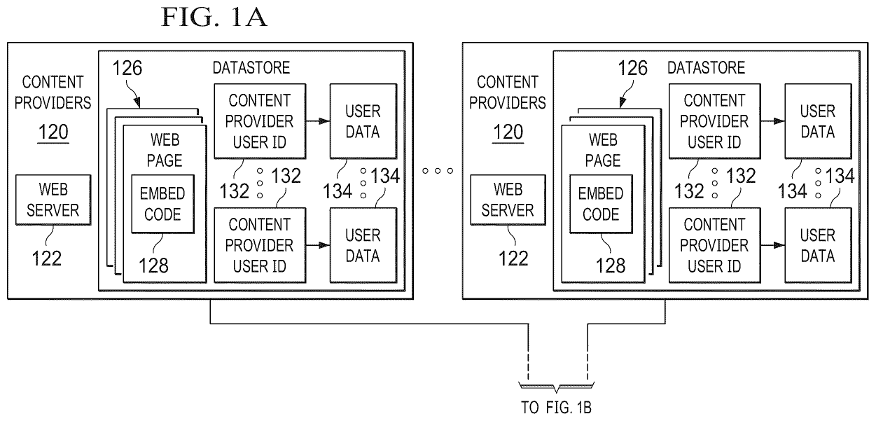

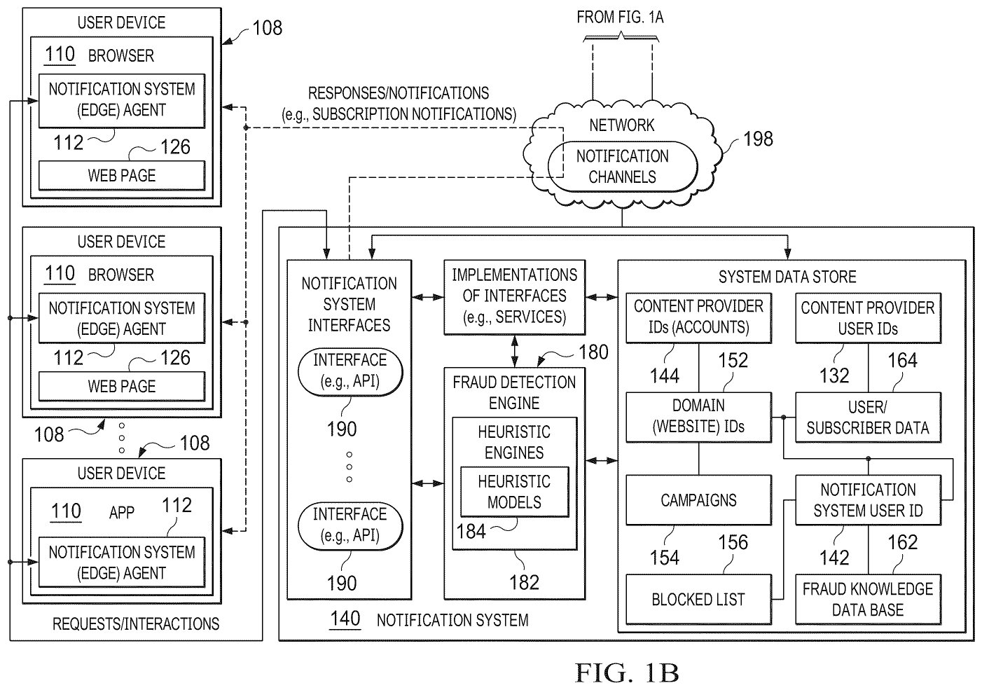

Looking at FIG. 1, then, one embodiment, a diagram of an architecture of a distributed networked computing environment computer including an embodiment of a notification system is disclosed. Notification system 140 is coupled to user devices 108 and content providers 120 over network 198. The network 198 may be the Internet, a wide area network (WAN), a local area network (LAN), an intranet, an internet, a wired network, a wireless network (including a cellular network), or some combination thereof. Notification system 140 may include a system data store for storing data for use by notification system 140. It will be understood that this system data store may comprise a single data store, or may comprise multiple data stores or types of data stores that may be distributed or clustered data stores such that the data stored in the system data store may be stored in different types of, or differently architected, data stores with different performance characteristics.

Content provider 120 may be any for-profit or non-profit organization or entity (used herein interchangeably) that, as part of its operations, needs to conduct online activity. To facilitate interaction with users and conducting online activity with these users, the content providers 120 may include a web server 122 and one or more web pages 126 in an associated data store. These web pages 126 may, for example, be associated with one or more web sites or domains associated with the content provider 120. Users may access these web pages 126 through a browser 110 on user devices 108. These user devices 108 may be, for example, personal computers, laptop computers, mobile phones, watches or other wearable devices, or other data processing devices and may include a processor, a display (virtual or physical) and a user interface. Content providers 120 may also include other means of contacting users such as through a call center or other user touch points which may be online or offline.

Accordingly, content providers 120 may include user identifiers 132 (content provider user ids) associated with users who access their web sites or domains through web pages 126. Such a content provider user id 132 may be a unique value associated with the user such as an email or the like. For example, the content provider user id 132 may be a hash of a user's email (e.g., for security purposes) or other substantially unique identifier for a user. Moreover, a content provider 120 may have user data 134 associated with such a content provider user id 132. This data may be data collected on, or provided by, a user accessing web pages 126 of the content provider 120.

For example, a user may subscribe to notifications from a content provider 120. Such users may have opted into, or otherwise provided permission, to “subscribe” to receive notifications or other data from a content provider 120 (e.g., through the content provider 120 website 126 that they are accessing, or through another channel such as SMS, email, push notifications for an app, etc.). For example, a subscription can include a single messaging subscription which is generated when a user enables or allows notification permissions on a website. Content provider user ids 132 may be identifiers of users who have subscribed to receive notifications from the content provider 120.

Notification system 140 may thus be adapted to send such notifications to users who have subscribed to receive such notifications. Specifically, a subscription request may be sent to users at their user device 108 (e.g., in association with a user's access to, or interaction with, a web site or web pages of a domain). When the user indicates acceptance of the subscription (e.g., subscribes or opts-in to the subscription), this subscription can be noted at the notification system and subsequent notifications delivered (or initiated) by notification system 140. Those notifications can be delivered to the users at user devices 108 through one or more notification channels (e.g., through website 126, SMS, email, push notification for an app or another type of notification channel).

Thus, notification system 140 may store content provider identifiers (also referred to as an account or account identifier) 144 where each of those account identifiers 144 may be associated with, and identify, a content provider system 120 that desires to have notifications provided by the notification system 140 to their subscribers. Notification system 140 may also maintain a list of domains (or website) identifiers 152 for content providers 120 (e.g., the domains or web pages provided by a content provider 120 may be associated with account identifier 144 for that particular content provider 120). These domain IDs 152 may identify domains or websites associated with web pages 126 provided by the content providers 120 and be associated with various information such as interests, verticals, demographic information, etc. associated with these domains.

Moreover, for each of the content providers 120, the notification system 140 may maintain content provider user ids 132 for users associated with that content provider 120 (e.g., users who access the web sites or domains of that content provider 120 through web pages 126 or who have subscribed to notifications from that content provider 120). These content provider user ids 132 may be associated with the content provider id 144 for that content provider 120.

One or more web pages 126 provided by the organization 120 (e.g., website provider) may include an embed code 128. This embed code 128 can cause the web browser 110 rendering the web page 126 to request a notification system agent (also referred to as an edge, notification or display agent) 112 from notification system 140 or another location (e.g., if the edge agent 112 is not already present or executing on the user device 108). The embedded code 128 may comprise a script tag, an include tag or the like. The edge agent 112 may include code such as JavaScript or the like, which may be executed by the browser 110 at the user's device 108. An edge agent 112 may also be included in (e.g., embedded in) other applications (e.g., “apps”) that are executed or installed on a user device 108 (e.g., native application or the like).

In an embodiment, the edge agent 112 is a program or script which executes on a website (or within an application) and interacts with interfaces 190 (e.g. RESTful interfaces, Application Programming Interfaces, etc.), of the notification system 140. These interfaces 190 may be implemented in the context of, or utilized with a firewall or other system that serves to analyze or assist in regulating, blocking or otherwise evaluating or implementing security with respect to incoming requests or outgoing responses. The edge agent 112 can thus send requests to an appropriate interface 190 and receive a response to the request from the notification system 140. The edge agent 112 can thus facilitate the presentation of a subscription request to a user at the user device 108, communication of a rejection or acceptance of the subscription or the request, and delivery of subsequent notification to the user through communication with the interfaces 190.

Edge agent 112 is also configured to generate and track a user device identifier that identifies one or more subscribers corresponding to a user device 108. The edge agent 112 may create a unique user identifier associated with user device 108 or a user on the user device 108 that may be passed to notification system 140 and stored at notification system 140. In an embodiment, the notification system unique user device identifier 142 (SSUUID) (also referred to “notification system user device identifier” or “notification system user device identifier data”) may be stored in association with an identifier 144 of a content provider system 120. Advantageously, following the generation of the SSUUID the online events by a user or user device 108 may be identified and tracked. For example, edge agent 112 can report and log information about clicks and response to pushed notifications at the notifications system 140.

In one embodiment, the SSUUID 142 may be associated with a user who has (or will be/has been offered the opportunity to be) opted into or otherwise provided permission to “subscribe” to receive notifications or other data from a content provider 120 (e.g., through the content provider 120 website 126 that they are accessing or through another channel). For example, a subscription can include a single messaging subscription which is generated when a user enables or allows notification permissions on a website. In an embodiment, the SSUUID 142 that is generated can be coupled with subscriber registration details to enable registration of the subscription such as a subscription endpoint, one or more encryption keys required for notification delivery, a subscription expiration time, etc. Thus, for example, a subscription may allow a messaging system (e.g., associated with content provider 120), such as notification system 140, to send and deliver notifications to a user with such a subscription. Thus, this SSUUID 142 for a user may be stored at the notification system 140. Specifically, each of the SSUUIDs 142 for a user may be associated with a corresponding content provider user id 132 for each of the content providers 120 for which that user has subscribed to received notifications.

In this manner, notification system 140 may create, maintain, and update user/subscriber data 164. This subscriber data 164 may include data regarding a user (e.g., an SSUID associated with a user along with information regarding the website (e.g., domain) to which that user has been subscribed. This user/subscriber data 164 may be stored in a data store comprising a distributed database system configured for redundancy and high availability. In some cases, multiple copies of the data may be maintained to ensure continuity and up-to-date access.

An example of an entry of a subscription in such a subscriber data list 164 is as follows:

```
Subscription Data
{
  // a subscriber identifier
  “_id” : ObjectId(“660c27f408478a706e38a741”),
  // activity timestamps
  “lastDeliveredAt” : ISODate(“2000-12-31T18:00:00.000-06:00”),
  “lastAttemptedAt” : ISODate(“2000-12-31T18:00:00.000-06:00”),
  “lastErroredAt” : ISODate(“2000-12-31T18:00:00.000-06:00”),
  // whether a subscriber has been manually blocked
  “blocked” : false,
  // messaging channel
  “channel” : “webpush”,
  // keys for the associated website and account
  “accountId” : ObjectId(“660c27d68f6691fdc742dd5d”),
  “websiteId” : ObjectId(“660c27d0aa7f1680940525f7”),
  // Geo information, detected by IP
  “subscriberGeo” : {
    “dip” : “173.239.237.155”,
    “dcity” : “Austin”,
    “dstate” : “TX”,
    “dcountry” : “US”,
    “dtimezone” : “America/Chicago”,
    “dzip” : “78757”
  },
  // Device information
  “subscriberDevice” : {
    “userAgent” : “Mozilla/5.0 (Linux; Android 10; K)
AppleWebKit/537.36 (KHTML, like Gecko) Chrome/123.0.0.0 Mobile
Safari/537.36”,
    “deviceType”: “phone”,
    “platform”: “Android”,
    “platformVersion”: “10”,
    “browserName”: “Chrome”,
    “browserVersion”: “123”
  },
  // Device identifier
  “ssuuid”: “8bda672f-cdb2-4768-8095-54d29ebb9b27”,
  // Associated domain name
  “ddomain” : “www.domain.com”,
  “testGroup” : 2
}
```

To generate a SSUUID 142 for example, agent 112 may detect a set of idempotent functions invoked by a web browser 110 of a user device. The set of functions is used to generate an output or identifier specific to the user device's web browser state or configuration. Example functions include, but are not limited to, static details provided by the browser such as the useragent (edge agent) information, whether localStorage is enabled, rendering images using Canvas and WebGL which add more variation between devices depending on browser capabilities (e.g., available fonts), etc. In an embodiment, the agent 112 or notification system 140 generates a final unique value based on the combination of the output of the functions identified in the collection phase. For example, the unique identifier may be generated by concatenating the output of these functions and providing the concatenated outputs as an input to a one-way hashing function. Advantageously, the functions executed on the user device are idempotent, such that the same results are produced by the web browser 110 throughout the session as well as across multiple sessions on different websites. The generation and use of such an identifier may also be understood with reference to U.S. Pat. No. 11,677,848 entitled “Subscription Management and Web-Based Activity Tracking in a Computing Environment” by inventors Smith and Taylor and issued on Jun. 13, 2023, which is incorporated herein by reference in its entirety for all purposes.

Accordingly, each of the content providers 120 may desire to have notifications provided to their subscribers (users) based on one or more campaigns 154 that they can define or otherwise specify. Each of the campaigns 154 may thus be associated with an identifier 144 of the content provider 120 that defined the campaign 154. The campaign 154 may also be associated with a particular website 152 of the identified content provider 144 such that notifications in association with the campaign 154 may only be sent to users who subscribed through, or who are otherwise associated with, the identified website 152. The campaign 154 may also specify one or more rules for generating notifications based on that campaign, including targeting rules defining interests or other attributes associated with the campaign 154, content rules or identification for content to be included such notifications, etc.

The campaign 154 may also include restriction or timing rules on such as a (e.g., maximum) number of notifications that may be sent in a time period (or maximum number of notifications per user in a time period) that the content provider 120 desires, or any information the content provider 120 desires to be provided with a notification for the campaign 154. The campaign 154 may also include a specification of a delivery (or transport) notification channel through which they would like any notification associated with that campaign 154 to be provided. The campaigns 154 may be specified by a content provider 120 (e.g., a user associated with content provider 120) through an interface or through some other channel or mechanism provided by notification system 140 or operators of notification system.

Specifically, in one embodiment each campaign 154 may be associated with content defined in one or more content lists such that a set (or “bucket”) of content is associated with the campaign 154. Each content list or item of content defined in the content list may be associated with a content type. The set of content in a content list for a campaign may also be designated in various manners to indicate how (e.g., what channel) that content should be delivered in association with the campaign.

The campaign 154 may also include restriction or timing rules on such as a (e.g., maximum) number of notifications that may be sent in a time period (or maximum number of notifications per user in a time period) that the content provider 120 desires, or any information the content provider 120 desires to be provided with a notification for the campaign 154. The campaign 154 may also include a specification of a delivery (or transport) notification channel through which they would like any notification associated with that campaign 154 to be provided. The campaigns 154 or associated content list may be specified by a content provider 120 (e.g., a user associated with content provider 120) through an interface or through some other channel or mechanism provided by notification system 140 or operators of notification system 140. Notification system 140 may thus provide interfaces or other notifications in association with campaigns 154 using notification system interfaces 190 such that display agent 112 present on the user's device 108 may present such interfaces or notifications.

As the notification system 140 may be associated (e.g., manage) subscriptions and delivery of notification for multiple (publisher) domains (e.g., associated with content providers 120), the notification system 140 may be uniquely positioned to track user behavior or other user data associated with a user's interactions across these multiple domains to store such data in a fraud knowledge database 162, and associate this behavior across these sites with the same identifier (e.g., SSUUID 142).

Fraud knowledge base 162 may thus include a number of logs of user's access to a website, including data such as: event_timestamp—a timestamp of the visit, SSUUID, ipa—IP address, website—an id of a particular website or domain, vertical—associated website vertical, tags—optional identifiers or day—date of the event (e.g., which may be used as a partition key).

| event_timestamp | SSUUID | ipa | website | vertical | tags | day |
|---|---|---|---|---|---|---|
| 2024-01-25 | f01a1b75-0070- | 166.173.217.80 | 660c24046dd2435ffcaf21bf | other | { } | 2024 |
| 07:04:21.000 | 4c9d-a99e- | | | | | Jan. |
| | 38fc9f739291 | | | | | 25 |
| 2024-01-25 | d3914991-2e28- | 11.230.178.245 | 660c240b77514559fbc738a1 | background | { } | 2024 |
| 07:04:18.000 | 4d72-8d13- | | | | | Jan. |
| | 8cc8b9dcffa6 | | | | | 25 |
| 2024-01-25 | c34a5973-f3b2- | 166.173.217.80 | 660c240f4839a901191e00ff | other | { } | 2024 |
| 07:04:19.000 | 4357-9313- | | | | | Jan. |
| | c657f90daa7d | | | | | 25 |
| 2024-01-25 | 04a0b05f-ff6e- | 150.211.1.100 | 660c24137de8b59aaee90707 | promotional | { } | 2024 |
| 07:04:19.000 | 4a4f-902f- | | | | | Jan. |
| | 9213cfb1e7be | | | | | 25 |

Fraud knowledge database 162 may include a data store that stores data from a streaming data pipeline that substantially continuously collects and stores data into a scalable cloud storage that is organized in a data catalog for efficient querying and analysis. The data can, for example, be arranged according to date, allowing for easy retrieval and examination based on specific time frames.

The fraud detection engine 180 may analyze this behavior as tracked in fraud knowledge database 162 (e.g. with respect to a single site or multiple domains of multiple content providers 120) to determine which users are undesirable automated users (e.g., bots) and should therefore be blocked (e.g., from receiving notifications from the notification system). This analysis can be done, for example, utilizing heuristic engines 182, and applying such heuristic engines 182 to user data in fraud knowledge base 162 collected during the user's interaction with the notifications or multiple sites (e.g., as reported by edge agent 112). These heuristic engines 182 may include models 184 trained on the user data associated with user's interaction with the notification system 140 or the content providers' domains (e.g., as stored in fraud knowledge base 152), where these models 184 may include, for example, rules based models, machine learning models or other types of models.

For example, rules that may be applied by a model 184 to detect the user's should be blocked may include rules such as: detecting users by SSUID who have created more than 30 subscriptions within a 3 hour period, detecting users by SSUID who have visited more than 30 websites in an hour or detecting users by non-shared IP blocks who have subscribed more than 100 times in a day or other rules.

Such analysis for fraud by fraud detection engine 180 may occur dynamically, in real time, or may be off-line analysis that may occur, for example, on a periodic basis, such as nightly or the like. To illustrate first with respect to real-time fraud detection, as notification system 140 may operate to allow a user to opt in, or subscribe, to (e.g., push) notifications, such a fraud analysis by fraud detection engine 180 may take place at least at two points in real-time during a user's interactions with notification system 140 or domains (e.g., web pages 126) or when notifications are sent to the user (e.g., based on a user's interaction with such notifications). Namely, before a user is presented with an opt-in or subscription request (e.g., is presented with an option to accept/opt-in or decline a subscription request) or after a user accepts a subscription request, a fraud analysis may be performed by fraud detection engine 180. Specifically, when a user accesses a web page 126 (e.g., of a web site provided by a content provider 120) edge agent 112 may send SSUUID 142 to notification system (e.g., in a request to an interface 190), it can then be determined if a subscription request (notification) is to be sent to the user for the domain associated with the web page 126. A fraud detection may be performed by fraud detection engine 180 before such a subscription notification is sent to the user to determine if the user should be blocked (e.g., from receiving a subscription notification or any subsequent notifications). By performing such an analysis prior to showing such a subscription notification (e.g., opt-in), the detection of fraud may be timed so that if the user is blocked the subscription notification (e.g., opt-in prompt) is skipped. The skipping of the subscription may have the advantage of making it more difficult to detect (e.g., compared to showing such an opt-in and blocking a subscription afterwards).

In particular, such a fraud analysis may include a check to see if the SSUUID 142 associated with the user has previously been blocked or if an IP address associated with the user has been previously blocked. Blocked SSUUIDs 142 or blocked IP addresses may, for example, be included in blocked list 156 of SSUUIDs 142. This blocked list may include a set of blocked SSUUIDs or Ips along with other blocking data such as when the SSUUID or IP address was blocked and what triggered the blocking of that SSUUID or IP address. For example, an entry in blocked list 156 may be as follows:

| SSUID | blocked_at | block_reason |
|---|---|---|
| 5dc3a74b-19f4- | 2024-04-02 | rule#4 |
| 45bf-a2d3- | 10:26:08.329 | |
| 8ade3dbe0f0d | | |

| ip | blocked_at | block_reason |
|---|---|---|
| 173.239.237.155 | 2024-04-02 | rule#4 |
| | 10:26:08.329 | |

In one embodiment, this blocked list 156 may be stored in a high-performance, distributed key-value database cluster designed for scalability and low-latency access to data. This type of data store may provide robust storage capabilities for managing large volumes of key-value pairs across multiple servers to ensure fast retrieval and high availability of such a blocked list 156.

If the SSUUID 142 or IP address associated with the user has been blocked, the user (e.g., the “user” associated with the SSUUID 142 where fraud was detected) may be blocked (e.g., no subscription notification or any other notification may be sent to that user). A denial may be communicated back to edge agent 112. In one embodiment, the user may be (re) directed to a blocked access web page that may be associated with the website that the user is accessing (e.g., provided by the provider of that website, associated with the same domain, etc.). Moreover, blocked data may be added to the user's device 108 to identify the user as blocked. This blocked data may be added to local storage at the user's device to mark the browser 110 or application 110 on the user's device as blocked.

If the SSUUID associated with the user has not been blocked), a heuristic engine 182 may be applied to determine if the user is a bot. If the user is identified as a bot, the SSUUID associated with the user (or the user's IP address) can be added to blocked list 156. Moreover, any subscriptions to notifications (e.g., from other sites) associated with the SSUUID 142 may be removed (or noted) at the notification system 140 such that interactions with that user may be curtailed or eliminated in association with other sites as well. Specifically, the SSUUID 142 associated with the user may be removed from all subscriptions in association with content provider IDs 144 or domain website IDs 152 such that the user identified by the SSUUID 142 may be “unsubscribed” from all domains to which it was previously subscribed. Such a removal may entail accessing subscription data 164 to determine all entries (e.g., subscriptions) in subscription data 164 associated with that same SSUUID or IP address and flagging those entries (e.g., by setting a “blocked” flag to true).

Fraud detection may also take place asynchronously to user interaction with the notification system. Here, at some time interval fraud detection engine 180 may apply heuristic engines 182 to user data in fraud knowledge database 152 associated with one or more SSUUIDs 142. These heuristic engines 182 may be adapted to apply heuristic models 184 to detect fraud based on user's interactions across domains to detect if such interactions across domains provided by multiple content providers 132 indicate that the user is a bot. Thus, a certain activity on one site (e.g., by a particular user) may be flagged as suspicious (e.g., without blocking that user), and when that activity (or similar activities) happen on several sites it can then be identified as fraud (e.g., a bot). In other words, the same, or a similar, activity on multiple sites by the same user may be utilized to make the determination. For example, if a subscription to notifications is detected in association with a certain number of domains in a certain time period, this user may be determined to be a bot. If the user is identified as a bot, the SSUUID 142 associated with the user can be added to a blocked list 154. Moreover, any subscriptions to notifications associated with the SSUUID 142 may be removed (or noted) at the notification system 140 such that interactions with that user may be curtailed or eliminated in association with all domains 152. Specifically, the SSUUID 142 associated with the user may be removed from all subscriptions in association with content provider IDs 144 or domain website IDs 152 such that the user identified by the SSUUID 142 may be “unsubscribed” from all domains to which it was previously subscribed.

Accordingly, embodiments may apply fraud detection in real time before, during, or subsequently to, interactions. In certain embodiments, then, the heuristic models 184 applied to detect fraud may be tailored to the particular context in which they will be applied. For example, heuristic models 184 may be tailored for real-time application, asynchronous application, application before a subscription notification is sent, etc. Moreover, when such fraud is detected for a user (e.g., the user is determined to be a bot, or other type of undesirable automated user), the SSUUID 142 may be added to a blocked list 154 such that the user is blocked even when that user interacts with other domains for other content providers 120. In other words, the user can be simultaneously blocked across all content providers' domains in the notification environment (e.g., even if that user is detected as fraudulent with respect to less than all of the content providers' domains).

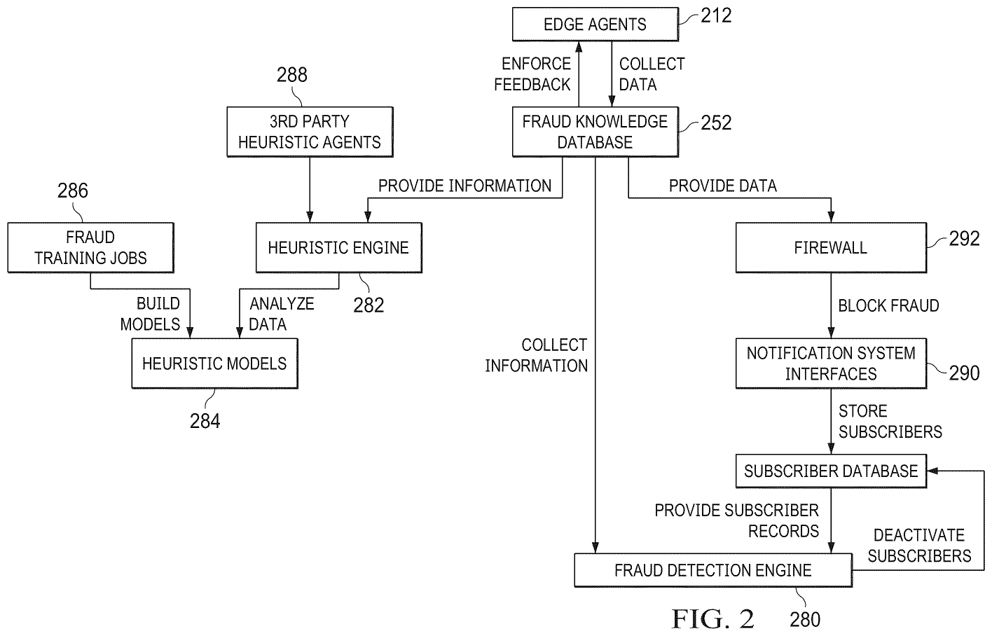

Embodiments as disclosed may be better understood with respect to the remainder of the figures where FIG. 2 depicts an architecture diagram of one embodiment of a fraud detection in a notification system. Here, heuristic engine 282 is a component responsible for detecting behavioral fraud in the notification system. Heuristic engine 282 processes the data collected by edge agents 212 and stored in the fraud knowledge database 252, utilizing heuristic models 284. Additionally, in some embodiments, information from 3rd party heuristic agents 286 may also be used to identify patterns, anomalies, or deviations that may indicate fraudulent activity. The heuristic engine 282 continuously adapts and refines its detection capabilities based on new insights and feedback (e.g., from edge agents 212 or data stored in fraud knowledge database 252).

Heuristic models 284 are used to perform the actual analysis functions within the heuristic engine 282. Heuristic models 284 are designed to identify patterns, anomalies, or deviations in user behavior or transaction data that may suggest fraudulent activity. Heuristic models 284 are built and refined periodically by fraud training jobs 286 to improve the accuracy and effectiveness of the heuristic engine 282.

Specifically, these fraud training jobs 286 may run periodically to build and refine the heuristic models 284 used by the heuristic engine 282. They analyze historical fraud data, trends, and patterns, and use machine learning or other techniques to create and update the heuristic models 284 that drive the fraud detection process.

Fraud knowledge database 252 serves as the central repository for storing data collected by edge agents 212, as well as information related to known/detected fraud cases, patterns, and heuristics. The fraud knowledge database 252 includes data utilized by the heuristic engine 282 for evaluating potential fraud and data for feedback to edge agents 212 such that edge agents 212 can improve their data collection and enforcement capabilities. Additionally, the fraud knowledge database 252 may include data utilized by web application firewall 292 for blocking fraud attempts. In some embodiments, the fraud knowledge database 252 may be distributed, such that the fraud knowledge database comprises a collection of tables or other data structures in multiple data stores that may include, for example, high volume data in a data warehouse as well as key-value data.

Edge agents 212 operate on a network of content providers (e.g., publishers). Edge agents 212 collect data from devices (e.g., user devices), such as user behavior, transaction details, and device information. They send this data to the fraud knowledge database 252 for storage and analysis. Edge agents 212 may also receive and enforce feedback from the fraud knowledge database 252 to optimize their data collection and fraud prevention efforts.

In certain embodiments, certain data related to browser context or events or conversions may be collected at the user's device by the edge agent 212. For example, browser context collected by an edge agent 212 and sent to the notification system (e.g., to include in the user identifier or the fraud knowledge database 252 may include:
userAgent—User Agent String, simplest, best metric
plugins—A list of named plugins available to the browser
platform—Browser Platform
cookiesEnabled—Whether cookies are enabled
timezoneOffset—The timezone of the browser/operating system?
resolution—Screen Resolution
localStorage—Whether the Local Storage API is available
sessionStorage—Whether the Session Storage API is available
canvas—Generates a Canvas image with a pangram, emoji and some shapes
webGL—Gathers device information on webGL rendering capability
cpuClass—CPU class
concurrency—CPU concurrency
indexdb—Whether indexdb is available
fonts—A list of named fonts the browser supports
language—Browser language
colorDepth—Screen color depth
touch—Whether the browser is running on a touch device
adblock—Whether AdBlock is detected as running

The edge agent 212 may also collect and track data related to events occurring on the user's device or with respect to a presented web page or notification presented by the notification system through the edge agent 212. The event data may be passed from the edge agent 212 to the notification system through an interface offered by the notification system and may include, for events:
frontend script (edge agent) detects a conversion from the user
Fields Visit—A device visits a webpage where the frontend script (edge agent) is loaded
Subscription—the frontend script (edge agent) detects that push notification permission has been granted
Delivery—A notification is delivered to the frontend script (edge agent)
Click—frontend script (edge agent) detects that a notification is clicked by the user

Certain interactions with the notifications may also cause the edge agent 212, including data related to:
time—An event timestamp
domain—The domain of the website where the event occurred
placement id—An identifier of the notification system installation
IP Address—the IP address of the client device
browser context data—described above

Embodiments may also determine derived user data associated with events at the notification system based on data reported from the edge agents 212 and this data stored with events (e.g., in the fraud knowledge database 252. This data may include, for example:
Connection type—A connection type (e.g. desktop, mobile) associated with the IP
Geolocation information—the detected city, state, country, timezone for the client IP address
Device information—the make, model, and product information for the device based on the edge agent.

3rd party heuristic agents 288 may be external agents that provide additional analysis and insights to the heuristic engine 282, supplementing the information derived from the heuristic models 284. By incorporating diverse perspectives and expertise, 3rd party heuristic agents 288 enhance the notification system's ability to detect and prevent fraud.

Firewall 292 serves as a protective layer that may block fraud attempts. Firewall 292 acts as an interface between the system and the interfaces 290 of the notification system and can be used to monitor and filter incoming requests to the interfaces 290 to prevent malicious activity from reaching the network. Thus, firewall 292 can be configured based on fraud detection performed by fraud detection engine 280 or through heuristic engine 280 to block, monitor, or filter requests (e.g., requests associated with a particular user identifier or the like). By blocking fraudulent requests or users, the firewall 292 helps maintain the security and integrity of the advertising ecosystem.

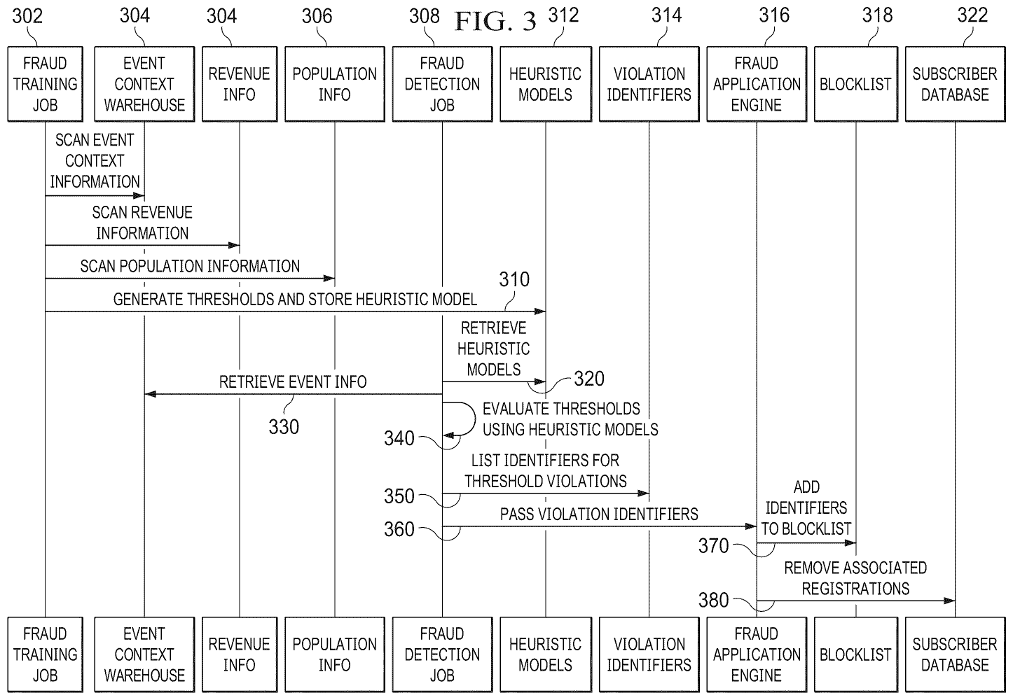

It may now be useful to an understanding of embodiments to discuss in more detail embodiments of a method for blocking fraudulent activity asynchronously to online activity (e.g., when a particular user is offline or does not have a session with a notification system). FIG. 3 depicts one embodiment of just such a process. Here a fraud training job 302 can access event context warehouse information (e.g., event data or fraud knowledge data) 304, revenue information (e.g. subscriber attributed revenue) 306, population information (e.g. counts of active subscribers from the subscriber database) 308, or other data. A fraud training job 302 may generate appropriate rules and appropriate thresholds and store a heuristic model 312 based on the accessed data (STEP 310).

At some point a fraud detection job 308 can access the heuristic models 312 stored by fraud training jobs 302 (STEP 320). The fraud detection job accesses a time period's worth (e.g., day) of event data such as that stored in a fraud knowledge database (STEP 330). The fraud detection job 308 evaluates thresholds defined in the heuristic models 312 (e.g., rules criteria, machine learning criteria, etc.) against the event data to identify fraud (e.g., violations of the models, rules or thresholds) and associated user identifiers (e.g. SSUUIDs) for that fraud (STEP 340). The fraud detection job 308 lists the identifiers (e.g., SSUIDs) for violations of the thresholds and passes the violation identifiers to a fraud engine 316 (STEP 350). The fraud engine adds the identifiers (e.g., SSUUIDs) to a block list and removes associated registrations (e.g., subscriptions associated with that SSUUID) from a subscriber database at the notification system (STEPS 360, 370).

As but one example, user interactions detected by a subscription opt-in script may be recorded by a notification system in the fraud knowledge database. These interactions may comprise, for example, mouse movements (x, y coordinates), clicks, and timestamps. A fraud training job comprising a supervised process could be used to label fraudulent session data focusing on a specific feature like mouse movement linearity. A heuristic model could be trained and evaluated with this data, for example flite. The edge agent executing on a user's device could then load this model on the user's devices and use real-time data to infer fraud. This fraud status could be subject to a threshold, beyond which a user would be blocked from subscription.

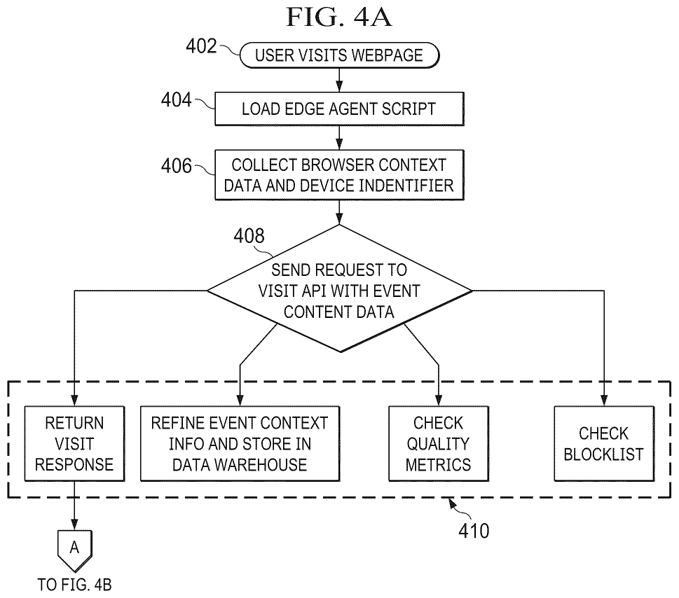

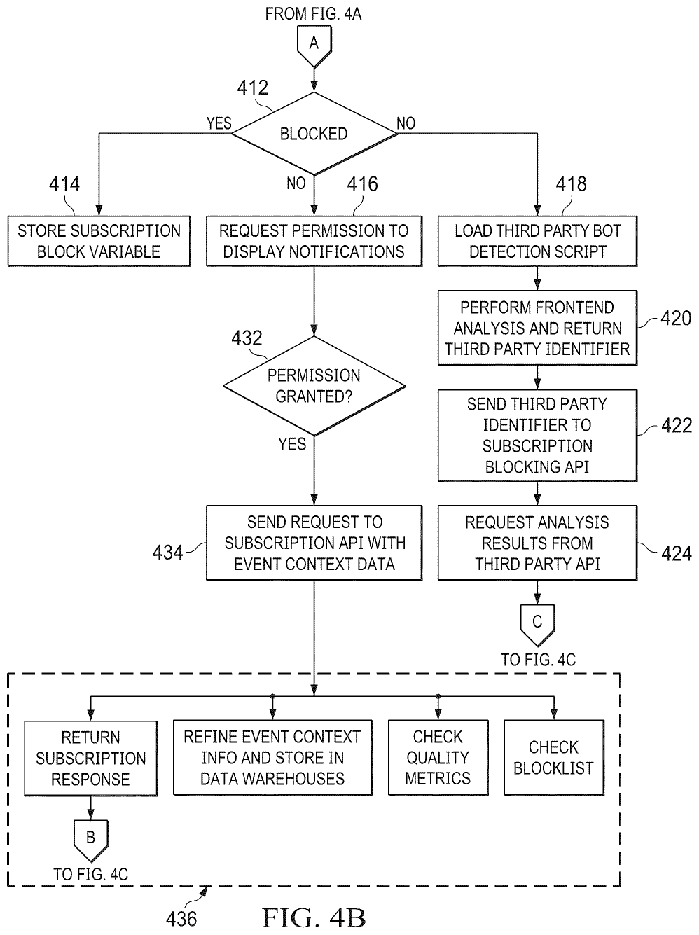

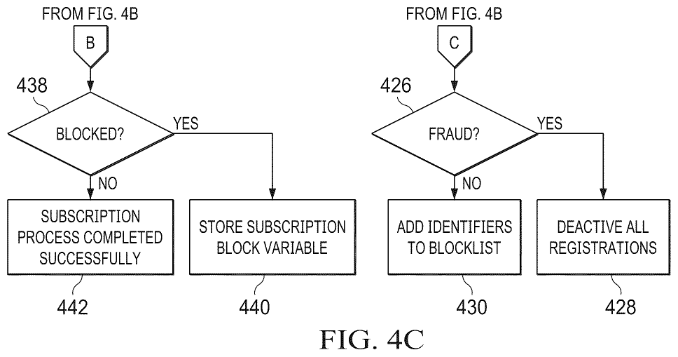

FIGS. 4A, 4B and 4C depict one embodiment of a process of blocking fraudulent activity with respect to a user's online activity (e.g., when a user, or edge agent, is interacting with the notification system). When a user visits a web page of a domain the loading of an edge agent is triggered (STEPS 402, 404). The edge agent collects browser context data and a (e.g., user or device identifier such as SSUUID) (STEP 306). The edge agent sends a request to an interface (e.g., referred to as a Visit API) at the notification system with event context data (STEP 408).

The service implementing this interface at the notification system performs several actions (STEP 410) including, for example, checking a block list of identifiers against identifiers in the event context information from the edge agent, checking quality metrics associated with the identifier in the event information based on configured thresholds, refining (e.g., cleansing or normalizing) the event context information and stores it in a data warehouse (e.g., a fraud knowledge database), and returning a response to the user.

In this embodiment, the edge agent may check if a response has been blocked (STEP 412). If the user (e.g., the identifier associated with the user) or the response has been blocked, the edge agent may store a subscription block variable (indicator) at the user device (STEP 414). If the user (e.g., the identifier associated with the user) or the response has not been blocked, the edge agent may request permission to display notifications at the user device (STEP 416). In some embodiments, the edge agent may also load or request any third party bot detection scripts that may be employed (STEP 418). These third party bot detection scripts may perform front end analysis (e.g., at the user device) and return a third party identifier to the edge agent on the user device (STEP 420). This third party identifier may be associated with a fraud detection analysis that will be performed by the third party system on the user and may allow results or other data associated with that analysis to be obtained, accessed or understood or associated with the user.

The edge agent can then send this third party identifier to the notification system (e.g., through an API referred to as a subscription blocking API) (STEP 422). This third party identifier can, for example, be associated with an identifier for the user (e.g., the SSUUID corresponding to the user). The notification system (e.g., the service responsible for implementing the subscription blocking API) may request analysis results from a third party API (e.g., associated with the third party bot detection script) using the third party identifier provided by the edge agent and associated with the user (STEP 424). If fraud is detected by the third party script (STEP 426), the service may remove associated registrations (e.g., subscriptions associated with that SSUUID) from a subscriber database at the notification system and add the identifiers to a block list for blocking future requests (STEPS 428, 430). Referring back to FIG. 4B, if a response has not been blocked, it may be checked to see if a request for permission to display notifications is allowed (STEP 416). If allowed (STEP 432) the edge agent may send a request to an API at the notification system (e.g., the subscription API) with event context information (STEP 434). The service responsible for implementing this interface at the notification system (e.g. the subscription API) may perform several actions including: checking a block list of identifiers against identifiers in the event context information from the edge agent, checking quality metrics associated with the identifier in the event information based on configured thresholds, refining (e.g., cleansing or normalizing) the event context information and storing it in a data warehouse (e.g., a fraud knowledge database), and returning a response to the user (STEP 436).

In this embodiment, it can be checked if a response has been blocked (STEP 438) If the user (e.g., the identifier associated with the user) or the response has been blocked a subscription block variable (indicator) may be stored at the user device (STEP 440). If the user (e.g., the identifier associated with the user) or the response has not been blocked, the edge agent may complete the subscription process and notifications may subsequently be provided from the notification system (STEP 442).

The invention and the various features and advantageous details thereof are explained fully with reference to the nonlimiting embodiments that are illustrated in the accompanying drawings and detailed in the description. Descriptions of well-known starting materials, processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure.

Generally then, the invention has been described with reference to specific embodiments. However, one of ordinary skill in the art appreciates that various modifications and changes can be made without departing from the scope of the invention. Accordingly, the description is to be regarded in an illustrative rather than a restrictive sense, and all such modifications are intended to be included within the scope of invention.

Although the invention has been described with respect to specific embodiments thereof, these embodiments are merely illustrative, and not restrictive of the invention. The description herein of illustrated embodiments of the invention is not intended to be exhaustive or to limit the invention to the precise forms disclosed herein (and in particular, the inclusion of any particular embodiment, feature or function is not intended to limit the scope of the invention to such an embodiment, feature, or function). Rather, the description is intended to describe illustrative embodiments, features, and functions in order to provide a person of ordinary skill in the art context to understand the invention without limiting the invention to any particularly described embodiment, feature or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Reference throughout this specification to “one embodiment,” “an embodiment,” or “a specific embodiment,” “a specific implementation,” or similar terminology means that a particular feature, structure, or characteristic described in connection with the embodiment is included in at least one embodiment and may not necessarily be present in all embodiments. Thus, respective appearances of the phrases “in one embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description, numerous specific details are provided, such as examples of components or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Any suitable programming language can be used to implement the routines, methods or programs of embodiments of the invention described herein, including C, C++, Java, assembly language, etc. Different programming techniques can be employed such as procedural or object oriented. Data may be stored in a single storage medium or distributed through multiple storage mediums, and may reside in a single database or multiple databases (or other data storage techniques.

A “computer-readable medium” may be any medium that can contain, store, communicate, propagate, or transport the program for use by or in connection with the instruction execution system, apparatus, system or device. The computer readable medium can be, by way of example, only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code).

Furthermore, the term “or” as used herein is generally intended to mean “and/or” unless otherwise indicated. As used herein, a term preceded by “a” or “an” (and “the” when antecedent basis is “a” or “an”) includes both singular and plural of such term (i.e., that the reference “a” or “an” clearly indicates only the singular or only the plural). Also, as used in the description herein, the meaning of “in” includes “in” and “on” unless the context clearly dictates otherwise.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. A notification system including fraud detection, comprising:
a processor; and
a non-transitory computer readable medium comprising instructions for:
maintaining a subscription data store, the subscription data store comprising a set of subscription entries for notifications from the notification system, each subscription entry associated with a unique user identifier for a user and a corresponding web site where the user is subscribed to notifications from the notification system;
maintaining a block list of unique user identifiers at the notification system;
receiving one or more events based on user interaction with a first website at a user device of a first user, wherein the first website was provided from a first content provider;
generating the unique user identifier for the first user;
based on the one or more events, determining that the first user is to be blocked from receiving notifications from the notification system because the first user is a bot;
placing the unique user identifier on the block list; and
evaluating each subscription entry associated with the first unique user identifier and, for each subscription entry associated with the first unique user identifier updating that subscription entry with a blocked user flag.

2. The notification system of claim 1, wherein determining that the first user is to be blocked from receiving notifications comprises applying a heuristic model to the one more or more events associated with the first user.

3. The notification system of claim 2, wherein the application of the heuristic model to the one or more events is done asynchronously to user interaction with the first website.

4. The notification system of claim 3, wherein the heuristic model is a machine learning model.

5. The notification system of claim 1, wherein the instructions are further for:
receiving one or more events based on user interaction with a second website at the user device of the first user, wherein the second website was provided from a second content provider; and
determining the user is blocked from receiving notifications in association with the second website based on the block list or the subscription data store.

6. The notification system of claim 1, wherein the instructions are further for storing blocking data at the user device, wherein the blocking data is adapted to prevent an edge agent on the user device from requesting notifications from the notification system.

7. The notification system of claim 1, wherein the instructions are further for: in response to determine that the user is to be blocked redirecting, by the notification system, the user to a blocked web page of the web site provided by the first content provider.

8. A method for fraud detection in a notification system, comprising:
maintaining a subscription data store, the subscription data store comprising a set of subscription entries for notifications from the notification system, each subscription entry associated with a unique user identifier for a user and a corresponding web site where the user is subscribed to notifications from the notification system;
maintaining a block list of unique user identifiers at the notification system;
receiving one or more events based on user interaction with a first website at a user device of a first user, wherein the first website was provided from a first content provider generating the unique user identifier for the first user;
based on the one or more events, determining that the first user is to be blocked from receiving notifications from the notification system because the first user is a bot;
placing the unique user identifier on the block list; and
evaluating each subscription entry associated with the first unique user identifier and, for each subscription entry associated with the first unique user identifier updating that subscription entry with a blocked user flag.

9. The method of claim 8, wherein determining that the first user is to be blocked from receiving notifications comprises applying a heuristic model to the one more or more events associated with the first user.

10. The method of claim 9, wherein the application of the heuristic model to the one or more events is done asynchronously to user interaction with the first website.

11. The method of claim 10, wherein the heuristic model is a machine learning model.

12. The method of claim 8, further comprising:
receiving one or more events based on user interaction with a second website at the user device of the first user, wherein the second website was provided from a second content provider; and
determining the user is blocked from receiving notifications in association with the second website based on the block list or the subscription data store.

13. The method of claim 8, further comprising: storing blocking data at the user device, wherein the blocking data is adapted to prevent an edge agent on the user device from requesting notifications from the notification system.

14. The method of claim 8, further comprising: in response to determine that the user is to be blocked redirecting, by the notification system, the user to a blocked web page of the web site provided by the first content provider.

15. A non-transitory computer readable medium, comprising instructions for:
maintaining a subscription data store, the subscription data store comprising a set of subscription entries for notifications from the notification system, each subscription entry associated with a unique user identifier for a user and a corresponding web site where the user is subscribed to notifications from the notification system;
maintaining a block list of unique user identifiers at the notification system;
receiving one or more events based on user interaction with a first website at a user device of a first user, wherein the first website was provided from a first content provider;
generating the unique user identifier for the first user;
based on the one or more events, determining that the first user is to be blocked from receiving notifications from the notification system because the first user is a bot;
placing the unique user identifier on the block list; and
evaluating each subscription entry associated with the first unique user identifier and, for each subscription entry associated with the first unique user identifier updating that subscription entry with a blocked user flag.

16. The non-transitory computer readable medium of claim 15, wherein determining that the first user is to be blocked from receiving notifications comprises applying a heuristic model to the one more or more events associated with the first user.

17. The non-transitory computer readable medium of claim 16, wherein the application of the heuristic model to the one or more events is done asynchronously to user interaction with the first website.

18. The non-transitory computer readable medium of claim 17, wherein the heuristic model is a machine learning model.

19. The non-transitory computer readable medium of claim 15, wherein the instructions are further for:
receiving one or more events based on user interaction with a second website at the user device of the first user, wherein the second website was provided from a second content provider; and
determining the user is blocked from receiving notifications in association with the second website based on the block list or the subscription data store.

20. The non-transitory computer readable medium of claim 15, wherein the instructions are further for storing blocking data at the user device, wherein the blocking data is adapted to prevent an edge agent on the user device from requesting notifications from the notification system.

21. The non-transitory computer readable medium of claim 15, wherein the instructions are further for: in response to determine that the user is to be blocked redirecting, by the notification system, the user to a blocked web page of the web site provided by the first content provider.
